(19) United States
(12) Patent Application Publication
(10) Pub. No.: US 2023/0394716 A1
(43) Pub. Date: Dec. 7, 2023

(54) METHOD OF GENERATING INFERENCE-BASED VIRTUALLY STAINED IMAGE ANNOTATIONS

(71) Applicant: PICTOR LABS, INC., Los Angeles, CA (US)

(72) Inventors: Kevin de HAAN, Los Angeles, CA (US); Yair Rivenson, Los Angeles, CA (US); Francesco Colonnese, Los Angeles, CA (US); Tairan Liu, Los Angeles, CA (US); Raymond Kozikowski, Los Angeles, CA (US)

(73) Assignee: PICTOR LABS, INC., Los Angeles, CA (US)

(21) Appl. No.: 18/319,843

(22) Filed: May 18, 2023

Related U.S. Application Data
(60) Provisional application No. 63/419,871, filed on Oct. 27, 2022.
(60) Provisional application No. 63/349,383, filed on Jun. 6, 2022.

(51) Int. Cl. G06T 11/00; G06V 20/69; G06V 10/82; G06V 10/774

(52) U.S. Cl. CPC G06T 11/00; G06V 20/69; G06V 10/82; G06V 10/774; G06T 2210/41; G06V 2201/03

(57) ABSTRACT

A method of generating virtually-stained image annotations. The method includes providing a neural network executed by image processing software. The image processing software runs on a processor of a computing device. The method includes training the neural network with a plurality of chemically stained patterns of endogenous signals to identify virtual staining patterns. The method includes producing and annotating an image of a biological sample for a biomarker. The biological sample includes endogenous signals. The method includes identifying, using the trained neural network, the virtual staining patterns in the image of the biological sample. Lastly, the method includes overlaying the virtual staining patterns in the image of the biological sample with annotations using spatial matching to produce virtually-stained image annotations.

### CROSS REFERENCE TO RELATED APPLICATIONS

This application claims the benefit of U.S. Provisional Application No. 63/349,383 filed Jun. 6, 2022 entitled VIRTUAL STAIN MULTIPLEXING USING LINEAR COMPUTATIONAL TRANSFORMS, and claims the benefit of U.S. Provisional Application No. 63/419,871 filed Oct. 27, 2022 entitled METHOD OF GENERATING INFERENCE-BASED VIRTUALLY STAINED IMAGE ANNOTATIONS, the contents of which are incorporated herein by reference in their entirety

### FIELD OF THE DISCLOSURE

The present disclosure relates to a virtual staining application used for biomarker discovery, tissue-based research studies, and diagnostic tests. More specifically, the present disclosure relates to a virtual staining methodology for the application of multiple immunohistochemical (“IHC”) staining techniques to the same tissue sample and same tissue location, independently, without requiring washing of the IHC stain or modification of the tissue. The virtual staining methodology described herein may also be combined with other existing virtual stains and conventional assay readouts to create new multiplexed readouts.

### BACKGROUND

Immunohistochemical analyses are frequently used for evaluation and diagnosis of various diseases by clinicians and researchers across many fields of medicine and biology. Within these fields, there is a growing demand for use of biomarker information to evaluate in situ protein expression in tumor tissues. As discussed in Immunohistochemical Staining Characteristics of Nephrogenic Adenoma Using the PIN-4 Cocktail (p63, AMACR, and CK903) and GATA-3, McDaniel, A., et al., Am. J. Surg. Pathol. 2014 December; 38(12):1664-71, Immunohistochemical staining characteristics of nephrogenic adenoma using the PIN-4 cocktail (p63, AMACR, and CK903) and GATA-3 chromogenic IHC staining is the most widely used methodology in this field, but the methodology is technically limited due to the number of tissue samples required per panel of IHC stain. This limitation requires repeated sampling of scarce tissues, which is often lengthy, impossible due to patient risk of tissue excision, and may result in human error.

Furthermore, IHC staining techniques require physical staining of each individual tissue sample. These techniques use “heat deactivation” steps between the application of each stain or assay, whereby the high heat applied to the tissue completely denatures the previous antibody-enzyme complex rendering it inactive for the application of the next IHC stain or assay. The use of heat deactivation steps also degrades the morphology of the tissue making it unusable for additional IHC staining or assay readouts. IHC staining techniques and assay read outs are susceptible to human error, which may lead to previous antibody-enzyme complexes remaining active. Such situations can result in erroneous staining patterns, which can cause false positive or false negative results.

The risk of errors increases with the number of analytes tested in a single tissue sample. As discussed in “The use of immunohistochemistry for biomarker assessment—can it compete with other technologies” in Toxicology Pathology, despite being semi-automated, multiplexing staining methods still have many drawbacks. Multiplexing staining methods are complex, labor-intensive, and time-consuming. For example, the increased number of automated fluid dispensing steps in a multiplexed staining procedure may lead to non-staining events, where the reaction fails to occur due to a missed dispense of fluid. In this case, a false negative result may occur without detection by the reviewing pathologist. Furthermore, due to steric hindrance from the application of antibodies and dyes, including non-specific background staining, it is not possible to create a generalizable method (i.e. a method where the order of stains applied and matching of antibodies and dye colors is not interchangeable) for multiplex tissue staining. As discussed in “Multiplex Immunohistochemistry: The Importance of Staining Order When Producing a Validated Protocol” in Immunotherapy, markers such as CD3 and CD8, which are membrane stains with overlapping binding domains, interfere with the staining results of each individual marker. In this case, the study showed a 90% drop in the amount of CD8+ staining cells when combined in a multiplex stain with CD3 as compared to the individual stains. Furthermore, it was shown that a CD20 marker could not be combined in a multiplex panel since the clinical protocol for this marker does not require heat-induced epitope retrieval, while these steps are required as part of a conventional multiplexed assay.

Different approaches have been developed to address some of the limitations described above and improve overall workflow. Recently, computational staining techniques have been developed using deep learning approaches to virtually stain tissue samples. Virtually staining tissues enables researchers to use a virtual stain on a digital image of a tissue, thereby reducing the need for physical tissue samples and eliminating errors found in conventional staining methods and assay readouts. However, the current methods of virtual staining only allow for one virtual stain per digital tissue image, thereby limiting the types of analyses that can be run on the digital tissues.

### SUMMARY

In view of the foregoing, there is a need in the art for a multiplexing staining technique that reduces time, increases efficiency and accuracy, and allows for reuse of the biological tissue sample.

The objective of the disclosure is to provide a virtual staining technique that allows for virtual stain multiplexing using virtual stains as well as traditional stain and assay readouts. Virtual staining based on an embodiment of the disclosure allows for multiple stains and assays to be applied to the same tissue sample, independently and in combination, without the need for washing of the traditional stain or modification of the tissue. In this way, different stains and assays may be applied to the same location multiple times. The present disclosure takes advantage of the unique property of virtual staining that enables customization and combination of multiple histological staining techniques.

In one embodiment, the method of the present disclosure includes capturing an autofluorescence image of a physical tissue sample mounted on a slide. Multiple images of the physical tissue may be taken to obtain the most accurate representation of the tissue. Once the image of the slide is satisfactory, the digital image is forwarded to the standard image pre-processing pipeline to prepare for inference-based virtual staining. Using the autofluorescence images, one or more neural networks can be used to infer multiple virtual IHC stains for the issue section. Now that the digital image has been created and stored, the image may undergo a second round of pre-processing prior to undergoing multiplexing.

After completion of the second round of pre-processing, the digital image of the stained tissue undergoes multiplexing. Here, the counterstain and the antibody-associated stains of the image are converted to either pre-specified stain vectors or eigenvectors, calculated using the image. In an embodiment where more than one biomarker is used, the stain is separated into three or more images, depicting each virtual antibody-associated stain in a separate image. Each image containing the separated virtual antibody-associated stain is then recolored to ensure that the different biomarkers can be differentiated when recombined. The recolored virtual antibody-associated stains and the counterstain are then recombined into a single image, and converted from the optical density color space to the standard RGB color space, where all three colors can be visualized.

In another embodiment, the tissue can be stained with traditional IHC staining techniques to identify specific biomarkers within the tissue after the autofluorescence imaging of the label-free tissue, if desired. Once the tissue is stained with a traditional antibody-associated stain or assay techniques, including but not limited to, 3,3′-diaminobenzidine (“DAB”) staining, mass spectroscopy, sequencing, and In Situ Hybridization (“ISH”). The IHC staining technique produces a stained tissue sample, which is then transferred onto a microscope slide having a barcode label, and covered with a coverslip for imaging. The slide undergoes brightfield or fluorescence whole slide imaging to obtain a digital image of the slide. The image undergoes quality control (“QC”) to identify images of tissue that would be unsuitable for processing. For example, instances including, but not limited to, where the image is evaluated for out-of-focus areas, missing tissue, cell count, necrosis, and other like features. Once the digital image of the slide is satisfactory, the digital image is forwarded to the same image pre-processing pipeline as the virtually stained tissues, and the components of the stain are computationally separated. These separated stains can then be merged with the virtual stain in the same manner described above.

The visualization of the staining combination can be customized according to the needs of any specific user. The colors used for each of the combined stains can be individually changed, and the intensity and opacity of each stain can be customized. This process may be performed in real time using a standard computer, allowing the user to immediately see the effect of the color changes on the tissue.

In another embodiment, an alternate process can be applied which does not require any deconvolution of existing stains during inference. Instead, the virtual staining networks can be trained to solely generate individual stains (i.e. only a counterstain, or only the antibody-associated stain) instead of generating a traditional mixed stain. These individual stains can then be combined based on the user's preferences. In a further embodiment, the virtual stains can also be generated using other modalities, such as brightfield images of stained tissue and used as the input of to the neural network to infer the images of the virtual IHCs. Additional imaging modalities that could be used to generate the virtual stains include, but are not limited to, brightfield, darkfield, fluorescence lifetime, Raman, hyperspectral, and harmonic generation microscopy along with phase imaging techniques and others used to image both labelled and label-free tissue.

In another embodiment an alternate process can be used as a framework that directly utilizes the virtual stains as an accurate means of providing annotations as input for a machine learning project. The quality of the annotations directly relates to the trained model prediction accuracy. Highly accurate virtual staining can delineate between subpopulations of cells, cells' state and signaling. Information from other channels, such as additional stains, sequencing or proteomic data may be used to provide accurate and rich annotations. This alternative workflow provides an advantage over the current tedious and expensive annotation process.

An inherent benefit of multiplexing with virtual stains from the same tissue section is the direct readiness for analytics. With conventional approaches to multiplexing, individual biomarker channels must be unmixed, have cell segmentation applied, and then determine presence or absence of biomarkers on specific cells. This computation is inefficient and may result in false positive or negative cells. In the virtual multiplex approach, each biomarker stain is individually rendered, ready for calling biomarker status without unmixing. In addition, there are no physical, chemical, or biological limitations to the number of virtual stains and assays that may be rendered within the same cell or cellular compartment, unlike conventional multiplex immunohistochemistry (“mIHC”) where steric hindrance and other effects limit the ability to apply multiple IHC stains.

The staining combinations produced by the virtual stain multiplexing in accordance with the present disclosure allow for novel workflows and numerous combined readouts. The expected benefits of the virtual staining methodology include advanced insights into cellular structure, protein targeting, diagnostic testing, and disease.

Furthermore, this disclosure enables stain customization according to user needs, including the specific configurations and intensities of multiple combined stains. Images of conventional IHC stains and virtual IHC stains can be separated into their individual constituents, and then merged in any possible combination. In so doing, the disclosure utilizes patterns from endogenous signals to digitally generate the tissue staining patterns arising from assays developed with an antibody, but do not require the use of the antibody or test kit in the deployed product.

It should be appreciated that the subject technology can be implemented and utilized in numerous ways, including, without limitation, as a process, an apparatus, a system, a device, a method for applications now known and later developed such as a computer readable medium and a hardware device specifically designed to accomplish the features and functions of the subject technology. These and other unique features of the system disclosed herein will become more readily apparent from the following description and the accompanying drawings.

### BRIEF DESCRIPTION OF THE DRAWINGS

The accompanying drawings, referred to herein and constituting a part hereof, illustrate preferred embodiments of the disclosure and, together with the description, serve to explain the principles of the disclosure.

FIG. 1 illustrates a standard configuration of a network design using parallel inference networks of inference-based virtual staining in accordance with the present disclosure.

FIG. 2 illustrates a second embodiment of the network design, where each inference-based virtual stainer produces a pure biomarker stain and a corresponding nuclear stain in accordance with the present disclosure.

FIG. 3 illustrates a third embodiment of the network design, where each inference-based virtual stainer produces a single output image of the pure biomarker stain in accordance with the present disclosure.

FIG. 4 illustrates a fourth embodiment of the network design, where a single inference-based virtual stainer is trained to produce a fully mixed multiplexed image, of all biomarkers combined with a nuclear counterstain in accordance with the present disclosure.

FIG. 5 illustrates a fifth embodiment of the network design, where a single inference-based stainer for a single biomarker produces two or more output images, in which the staining patterns of specific cellular sub-populations are partitioned among the images in accordance with the present disclosure.

FIG. 6 illustrates a sixth embodiment of the network design, where each inference-based virtual stainer produces a stain of the same biomarker on a sub-population of the cells, which are positive for the biomarker in the tissue section in accordance with the present disclosure.

FIG. 7 illustrates a virtual staining network that generates two separate representative IHC stains, using neural biomarkers markers GFAP and IBA1 in accordance with the present disclosure.

FIG. 8 illustrates the customized visualization of the staining combination used in FIG. 7.

FIG. 9 illustrates a method for creating a single nuclear counterstain layer given a set of virtual stains in accordance with the present disclosure.

FIG. 10 illustrates a method for mapping the colors from unmixed multiplexed IHCs together for visualization in accordance with the present disclosure.

FIGS. 11A-11B illustrate an embodiment for a laboratory workflow used to produce a hybrid assay result combining virtual staining and a conventional assay in accordance with the present disclosure.

FIGS. 12A-12B illustrate an embodiment of a computational workflow for digitally combining virtual staining results and a conventional assay results into a hybrid multiplex suitable for analysis or visualization in accordance with the present disclosure.

FIG. 13 illustrates an embodiment of a computational workflow for utilizing virtual staining for generating annotations for use in a machine learning model.

FIG. 14 is block diagram of a computer system arranged to perform processing associated with the neural network for inference-based virtual staining as described herein.

### DETAILED DESCRIPTION

The advantages, and other features of the method disclosed herein, will become more readily apparent to those having ordinary skill in the art from the following detailed description of certain preferred embodiments taken in conjunction with the drawings, which set forth representative embodiments of the present disclosure and wherein like reference numerals identify similar structural elements. It is understood that references to the figures such as up, down, upward, downward, left, and right are with respect to the figures and not meant in a limiting sense.

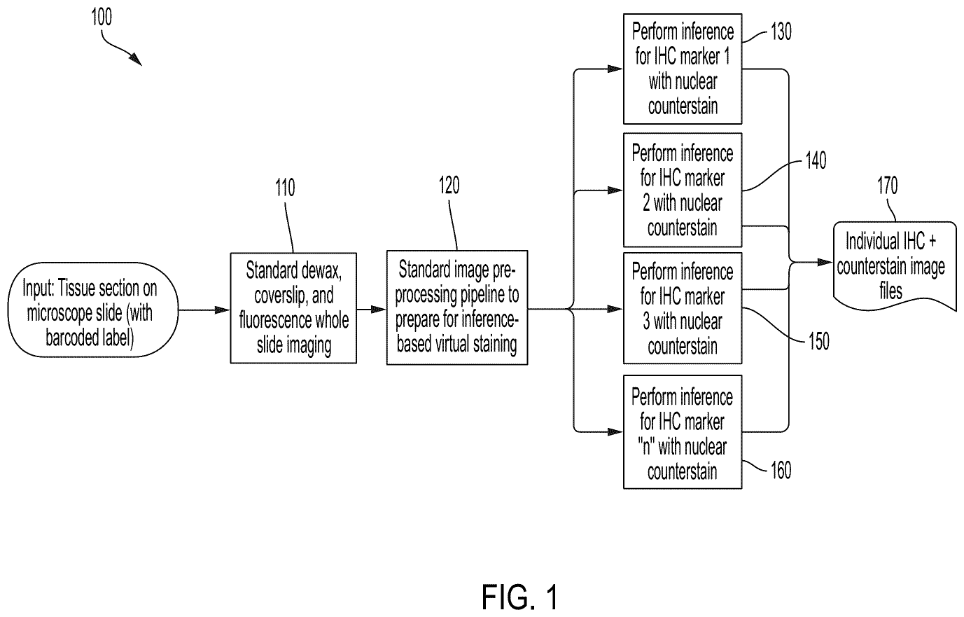

FIG. 1 illustrates a first embodiment 100 of a configuration of a network of inference-based virtual staining. At operation step 110, a tissue section is dewaxed and a coverslip is applied. In some cases, such as cytology or fresh frozen sections, dewaxing is not required. In other situations, the fluorescence image may be acquired without the application of a coverslip. The fluorescence of the entire slide is then imaged. At step 120, the image is preprocessed and prepared for inference-based virtual staining. At step 130, inference-based virtual staining is performed for IHC marker 1 with nuclear counterstain. This process is repeated n times, as illustrated in steps 140-160. Images are collected and stored for the stained IHC markers and associated nuclear counterstains in step 170.

For each biomarker of interest in the virtual multiplex panel, a network is designed and trained using single biomarker stains, and includes a nuclear counterstain. The network of inference-based virtual stains then produces virtually stained images with each biomarker of interest along with a nuclear counterstain. As seen in FIG. 1, the virtually stained images must then be unmixed into individual images each showing an isolated biomarker of interest, which are then combined with the nuclear counterstains for visualization in an individual image. The resulting individual image files may be used for detecting cells and biomarker status to feed into computational algorithms.

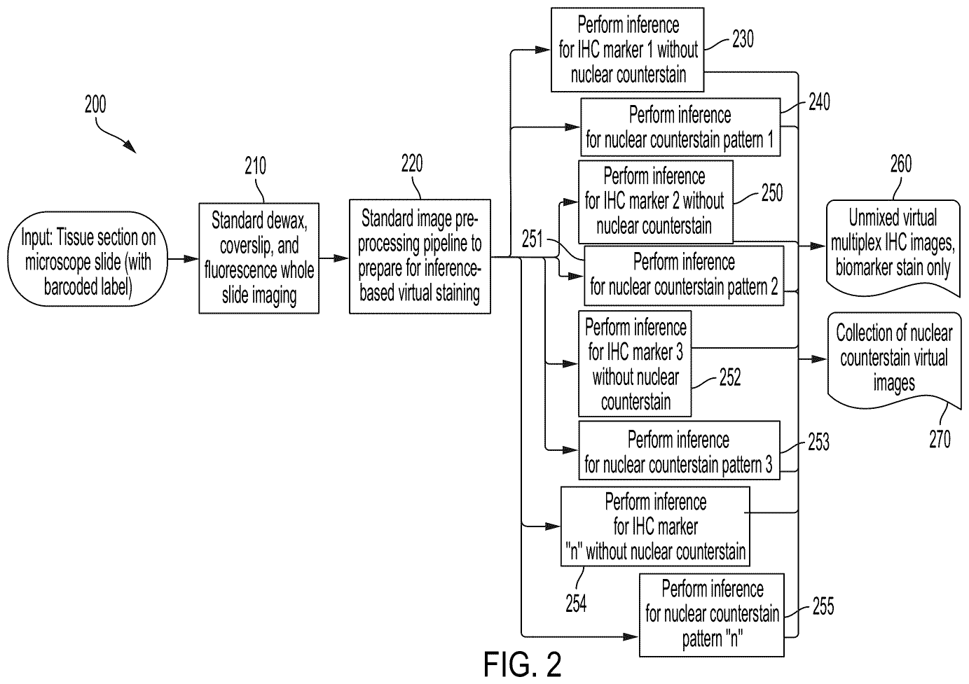

In a second embodiment 200, illustrated in FIG. 2, the coverslip is removed in step 210 and the tissue section on the microscope slide is dewaxed. The fluorescence of the entire slide is then imaged. At step 220, the resulting image is preprocessed and prepared for inference-based virtual staining. At step 230, inference-based virtual staining is performed for IHC marker 1 without nuclear counterstain. The inference based nuclear counterstain is performed independently of IHC marker 1 in step 240. This alternating inference-based virtual staining is performed for each IHC marker and nuclear counterstain and repeated n times, as illustrated in steps 250-255. Images are then collected and stored for the individually stained IHC markers in step 260 and for associated separate nuclear counterstains in step 270.

In this embodiment, the network of inference-based virtual staining produces two output image files, one of the pure biomarker stain and a second of a corresponding nuclear counterstain. In this way, the network of inference-based virtual stains unmixes the images of biomarker stain from the nuclear counterstain.

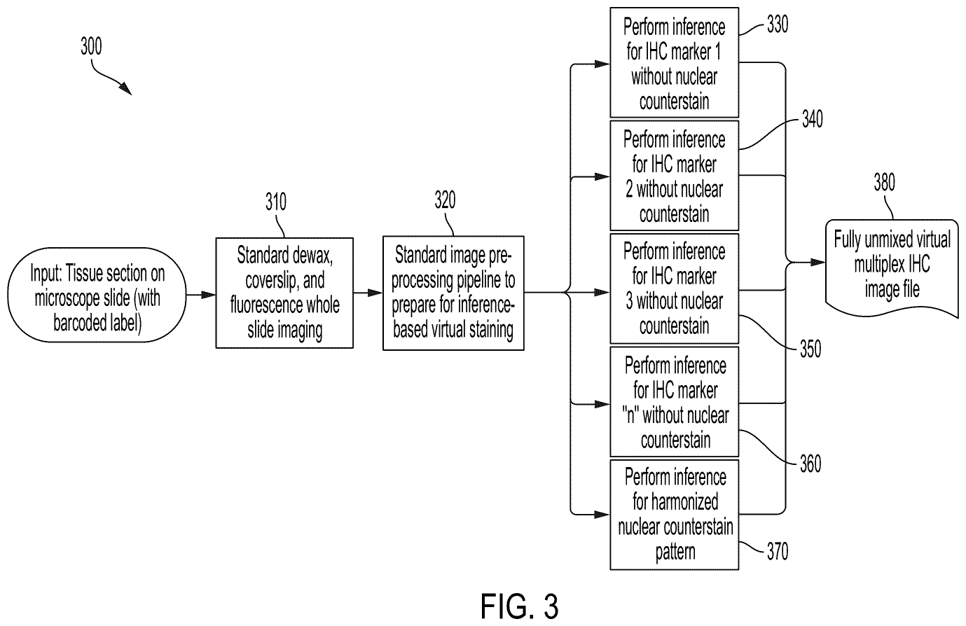

FIG. 3 illustrates a third embodiment of the disclosure 300 wherein each network of inference-based virtual staining produces a single output image file of the pure biomarker stain. At operation step 310, the coverslip is removed and the tissue section on microscope slide is dewaxed. The fluorescence of the entire slide is then imaged. Then at step 320, the resulting image is preprocessed and prepared for inference-based virtual staining. At step 330, inference-based virtual staining is performed for IHC marker 1 without nuclear counterstain. Inference-based virtual staining is performed for each additional IHC marker and repeated n times, as illustrated in steps 340-360. At step 370, inference based harmonized nuclear counterstain patterns are performed independently of the IHC markers. Fully unmixed virtual multiplexed ICH image files are created at step 380.

In the embodiment of FIG. 3, alongside each network of inference-based virtual staining is an additional network which produces a single nuclear counterstain image file. The single nuclear counterstain image file is applicable to any of the biomarker stains produced by the other network of inference-based virtual staining. In this way, virtual staining is seamlessly combined with unmixing the image files of biomarker stain from the nuclear counterstain as well as the recombination of nuclear counterstain image files to create a single reference nuclear counterstain.

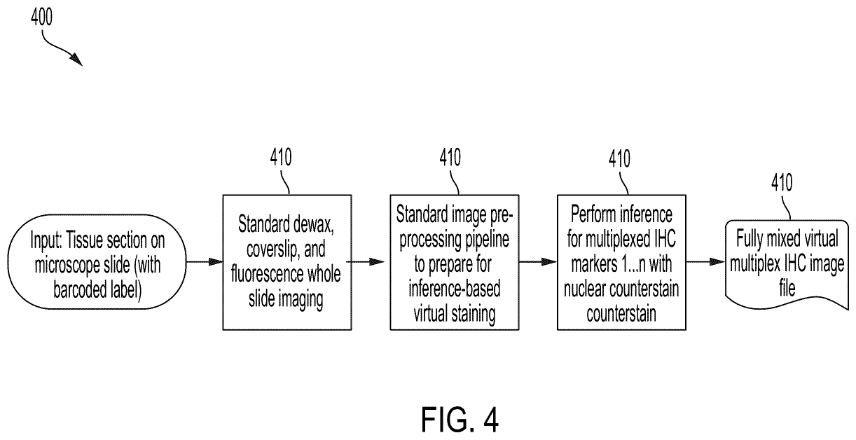

In a fourth embodiment 400 of the disclosure, illustrated in FIG. 4, a single inference-based virtual stain network is trained to produce a fully-mixed multiplexed image file, containing all available biomarkers combines with a nuclear counterstain. In this way, the inference-based virtual stain network combined the operation of virtual staining seamlessly with the remixing and application of color vectors to the biomarker stains required for visualization.

As illustrated in FIG. 4, the coverslip is removed and the tissue section on microscope slide is dewaxed in operation step 410. The fluorescence of the entire slide is then imaged. In step 420, the resulting image is preprocessed and prepared for inference-based virtual staining. Then in step 430, inference-based virtual staining is performed for each IHC marker 1 with nuclear counterstain. Fully mixed virtual multiplexed IHC image files are created at step 440.

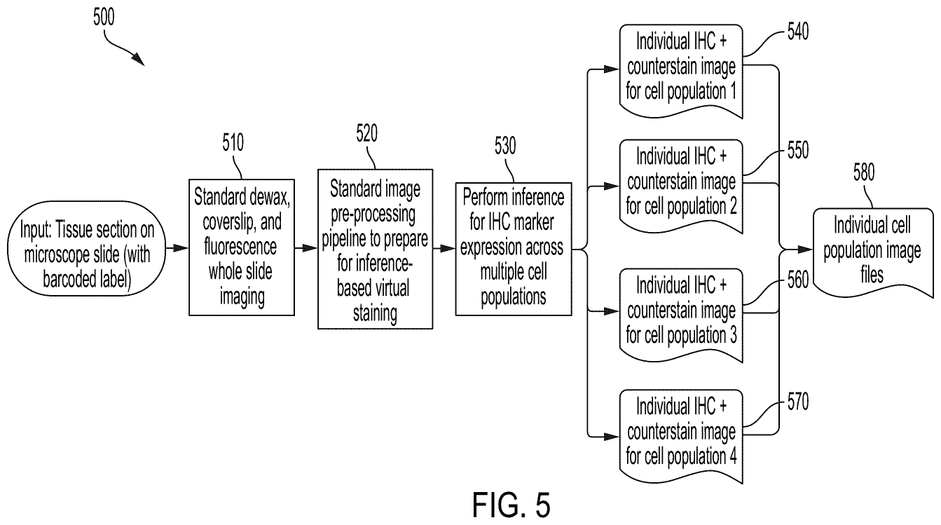

In a fifth embodiment, illustrated in FIG. 5, the method solely uses a single inference-based virtual stain network. Unlike other embodiments where all positive cells are stained for a biomarker by one single inference-based virtual stain networks and subsequent individual populations are stained by other single inference-based virtual stain networks, here, the single network is trained for a single biomarker that produces two or more output image files wherein the staining patterns of specific cellular sub-populations are partitioned among the images. The combination of those stains would comprise the total expected staining result from a conventional stain of the target biomarker. In this way, the unmixed cell populations, which are positive for the biomarker may be analyzed and visualized separately.

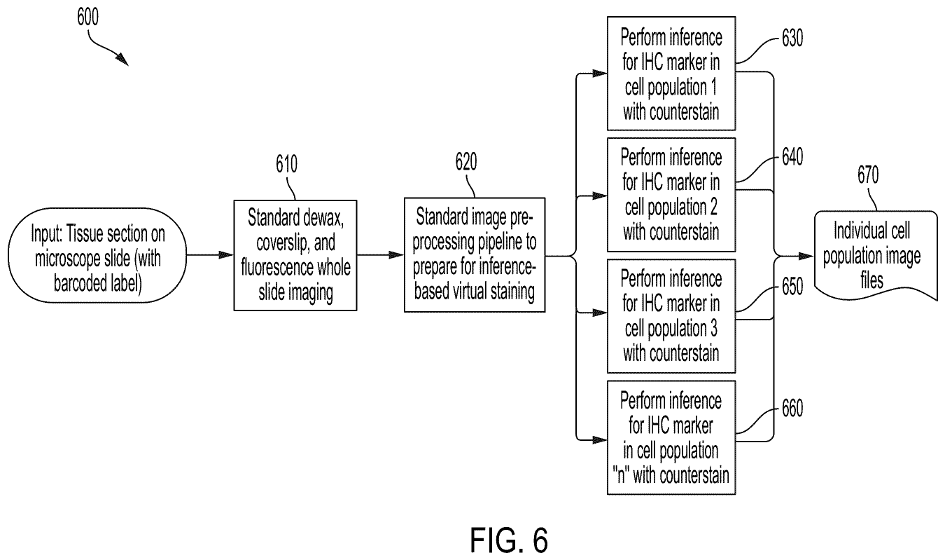

In another embodiment, illustrated in FIG. 6, the coverslip is removed and the tissue section on microscope slide is dewaxed at operation step 610. The fluorescence of the entire slide is then imaged. At step 620, the resulting image is preprocessed and prepared for inference-based virtual staining. At step 630, inference-based virtual staining is performed for the IHC marker with the associated nuclear counterstain for cell population 1. This combined inference-based virtual staining and counterstaining is performed for the IHC marker and associated counterstain and repeated n times for each cell population, as illustrated in steps 640-660. Then at step 670, the associated individual cell population image files are created. In this embodiment, each network of inference-based virtual staining produces a stain of the same biomarker, on a sub-population of the cells that are positive for the biomarker in the tissue section.

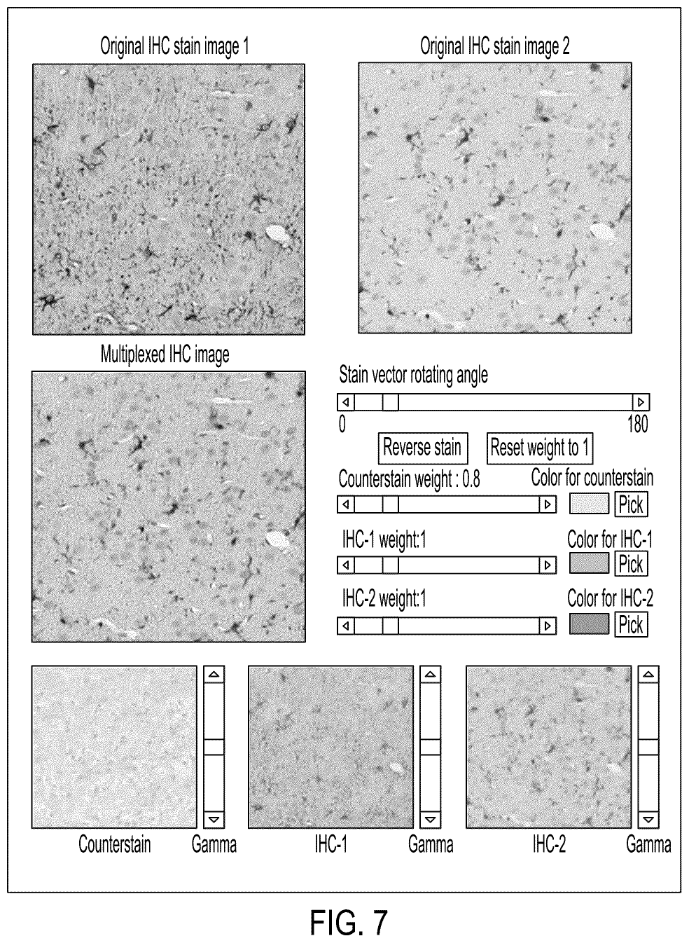

FIG. 7 illustrates the unique way that resulting images can be configured. The colors used for each of the combined stains can be individually changed according to a color pallet or according to their stain vector. The intensity of each component of the stains can be customized using the weight sliders. These intensities can be further changed using gamma correction to give the desired visualized intensity. In FIG. 7, virtual IHC 1 is neural biomarker GFAP and virtual IHC 2 is neural biomarker IBA1 which are both applied to tissue, such as rat tissue. The separated components of the two stains can be seen at the bottom of FIG. 7, where the separated counterstain from virtual IHC 1 is shown beside the separated DAB stains for both IHC 1 and 2. These separated stain components are then recombined according to the specified parameters to generate a multiplexed IHC image. This process can be performed in real time using a standard computer, allowing the user to immediately see the effect of the color changes.

An inherent benefit of multiplexing with virtual stains from the same tissue section is the direct readiness for analytics. With conventional approaches to multiplexing, individual biomarker channels must be unmixed, have cell segmentation applied, and then determine presence or absence of biomarkers on specific cells. The conventional computation is inefficient and may result in false positive or negative cells called for their biomarker status. In the virtual multiplex approach, each biomarker stain is individually rendered, ready for calling biomarker status without unmixing.

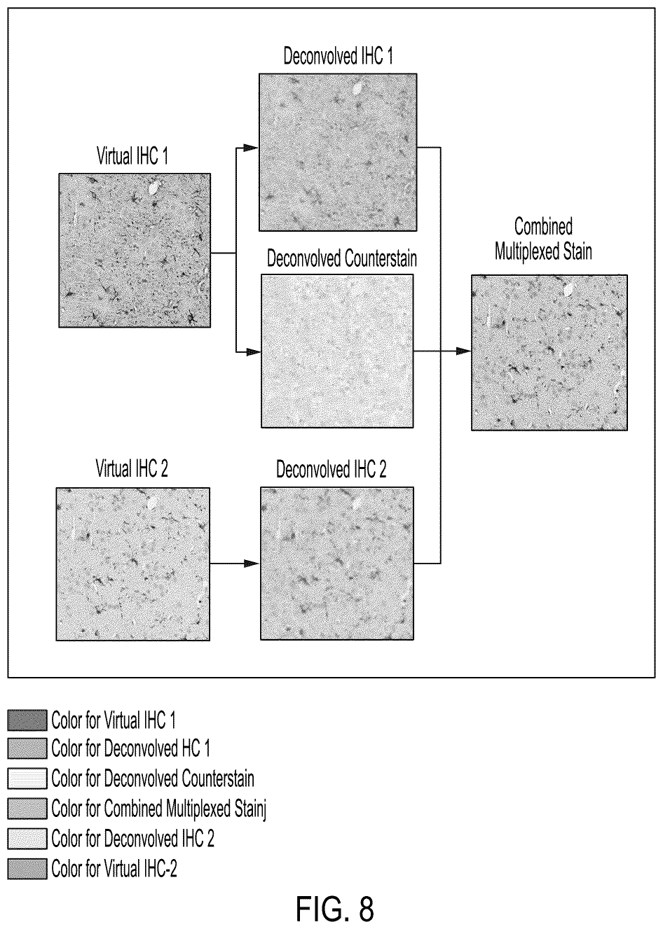

FIG. 8 illustrates how the visualization of the staining combination can be customized according to the needs of any specific user. Multiple IHC stains and counterstains are separated, IHC stain image files are recolored in order to be differentiated and then IHC stains and counterstain are recombined in a new image file. Here, the virtual staining network generates two separate neural biomarker mIHC stains (GFAP and IBA1). The mIHCs are initially performed by staining the biomarker with a DAB stain and the background is counterstained. The DAB and counterstains are separated, but only the counterstain from stain 1 is used. The two images containing the separated DAB stains are recolored to be differentiated.

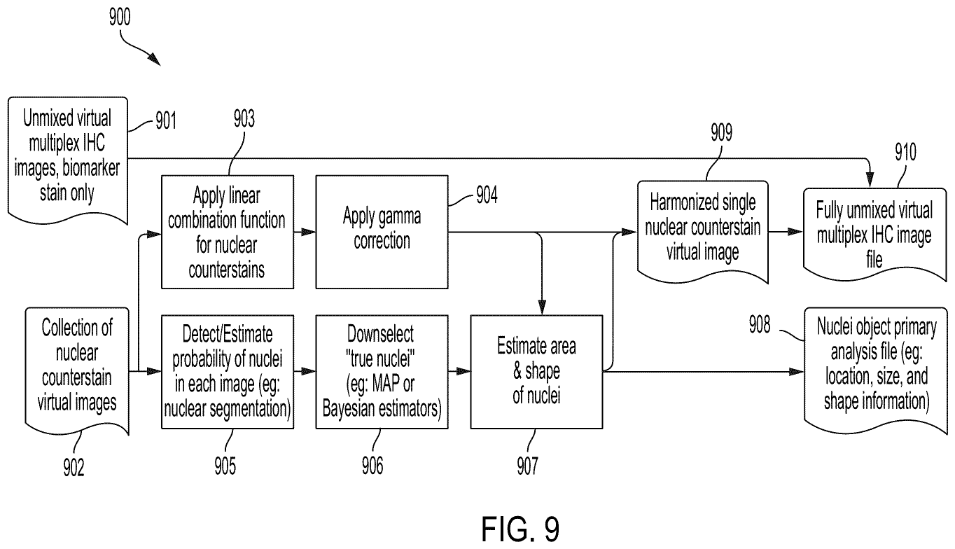

FIG. 9 demonstrates a method for unmixing a set of virtual stains and creating a single combined nuclear counterstain based on a combination of generated nuclear counterstains. In steps 901 and 902, the unmixed virtual IHC images and virtual counterstain images are generated, respectively. The counterstain images are color corrected by applying a linear function to the nuclear counterstains in step 903 and then by applying gamma correction if need in step 904 to achieve the desired contrast. Nuclei choice is determined by segmenting the nuclear counterstain images in step 905. In step 906, to determine the probability that a nucleus exists in a given area, the true nuclei are downselected using the combination of mappings. The combination of the downselected nuclei mapped in step 906 and the color corrected combination of counterstains in step 903 are used to identify and estimate the true area and shape of the nuclei in step 907. This estimation can be output for use in further analysis in step 908. In step 909, using the contrast adjusted counterstain, along with the shape of the downselected area, a harmonized single nuclear counterstain image is created. This nuclear counterstain image and the unmixed virtual multiples IHC images can be combined into a single file in step 910.

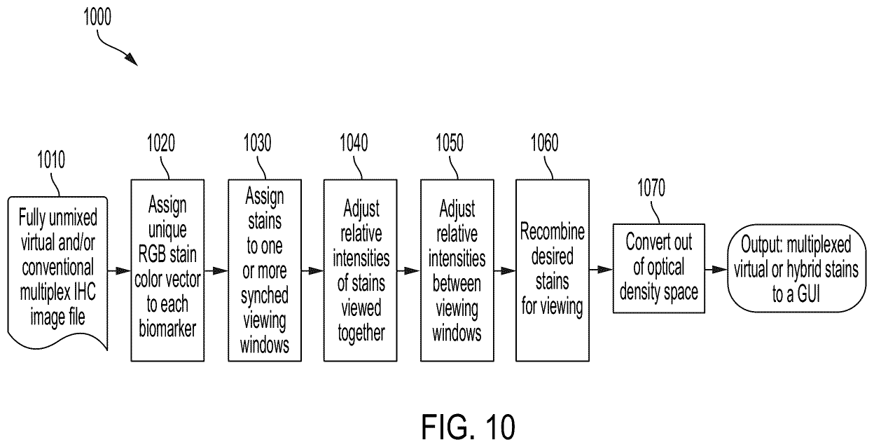

FIG. 10 illustrates the mapping of the multiplexed virtual IHC to different colors for visualization. To start, the images are unmixed in step 1010. Each component of the stain is then assigned a desired color in the RGB color space in step 1020. At step 1030 the stains are allocated to a specific viewing window, with all of the components being assigned to the same window if an overlay of all stains is desired. In step 1040 the relative intensities of the stains are adjusted to achieve the desired visualization. Then, the image is recombined in step 1060 and converted out of the optical density space in step 1070 to allow for visualization by the user.

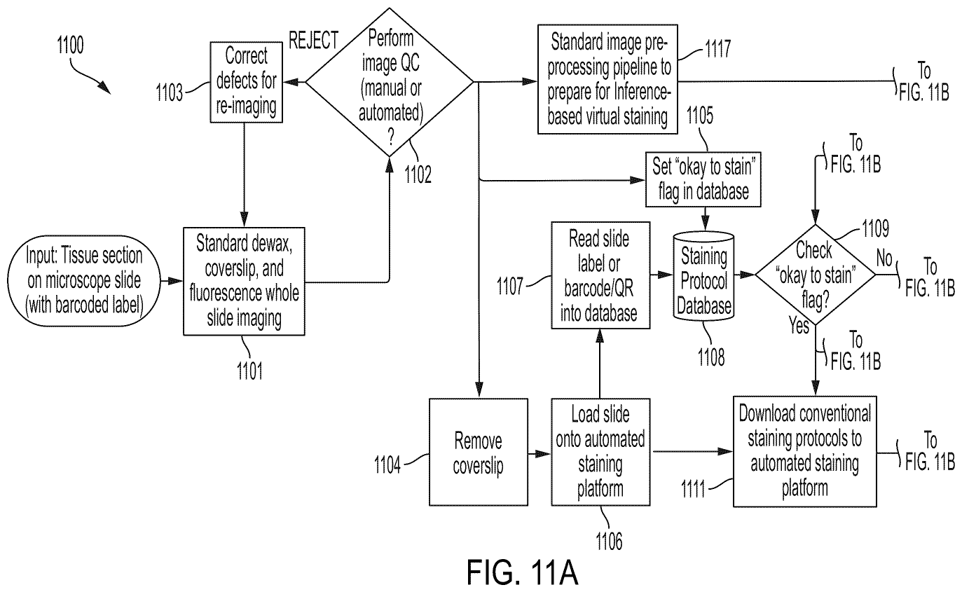

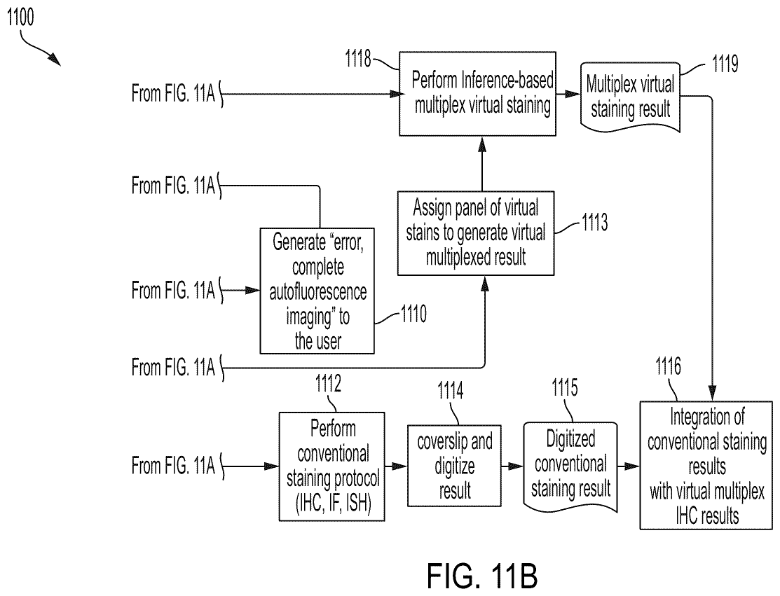

FIGS. 11A-11B illustrate an embodiment for a laboratory workflow used to produce a hybrid assay result combining virtual staining and a conventional assay in accordance with the present disclosure. The workflow beings at step 1101 where a tissue section mounted on a slide is deparaffinized (or dewaxed), coverslipped, and fluorescently imaged. In step 1102, QC of the image and tissue is performed to ensure the image meets the proper standards for virtual staining. If the image is rejected during QC, the sample may be reimaged or reprocessed in step 1103 to correct any defects, but is not passed forward for conventional staining. If the image passes QC, the coverslip is removed to prepare the sample for a conventional assay in step 1104. In parallel with step 1104, an “okay to stain” flag is set in the staining protocol database 1108 in step 1105, which permits the automated staining protocol to be performed. After coverslip removal, the slide is loaded onto the automated staining platform to perform the conventional assay in step 1106. A barcode on the slide is read in step 1107, which is referenced within the staining protocol database 1108 and the “okay to stain” flag is checked. If the “okay to stain” flag is not set, an error code is presented to the user in step 1110 and the slide is not permitted to be conventionally stained. If the “okay to stain” flag is set, then in step 1111 a conventional staining protocol is downloaded to the automated staining platform and that platform performs the conventional staining protocol in step 1112. At the conclusion of the conventional staining assay, a coverslip is applied, and the assay result is imaged and digitized in step 1114. The result of this conventional assay process is a digitized image of the result in step 1115, suitable for combination with virtual staining outputs in step 1116.

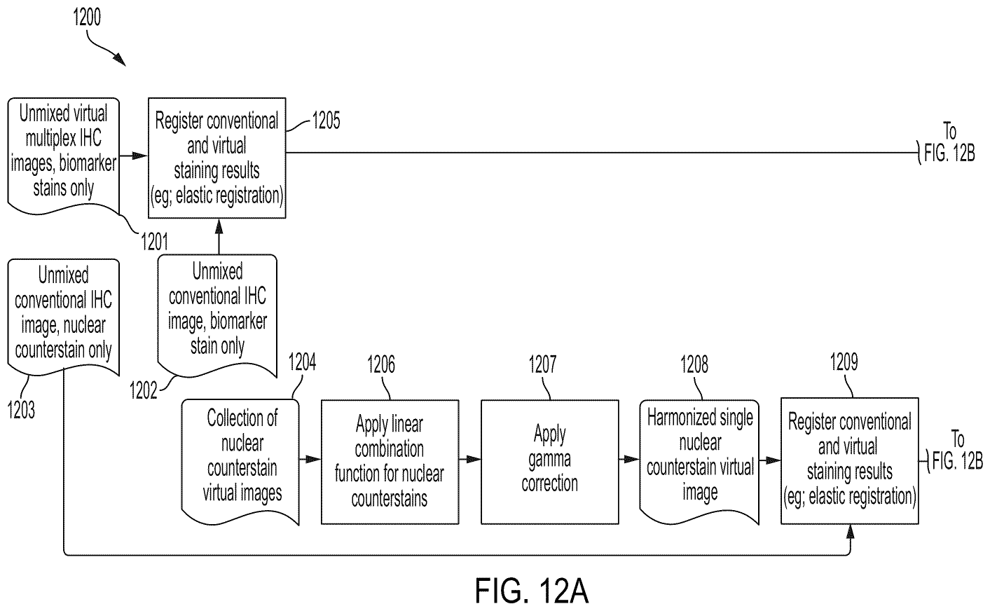

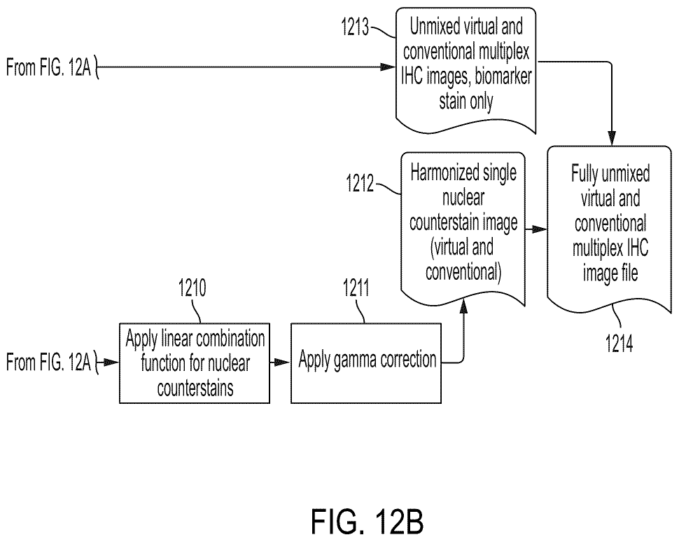

At the same time, the staining protocol database 1108 releases a panel of virtual stains, which comprise the virtual multiplexed staining result. This input is combined with pre-processing of the autofluorescence images done in step 1117, and at step 1118 where inference-based multiplex virtual staining is performed. Example methods of step 1118 are disclosed in FIGS. 1-6. In step 1119 a multiplexed virtual staining result is returned from the system. This result is combined with a digitized version of the conventional staining result in step 1116, an example embodiment of which is disclosed in FIGS. 12A-12B below.

FIGS. 12A-12B illustrate an embodiment of the unmixing and remixing process to digitally combine virtual staining results and conventional staining results into a hybrid multiplex suitable for analysis or visualization in accordance with the present disclosure. In step 1201, unmixed virtual multiplex IHC biomarker stains are presented to the system. In step 1202, unmixed conventional IHC biomarker stains are presented to the system. Step 1205 takes the output of steps 1201 and 1202 to preform registration between the two images. The objective of the registration step is to provide a common frame of reference for overlaying the images such that a pixel with a virtual staining result is aligned with the same pixel, which contains a conventional staining result. In parallel, the collected virtual counterstain images in step 1204 are prepared for registration with unmixed nuclear counterstain images from the conventional assay in step 1203. In step 1206, the virtual nuclear counterstain images are combined in a linear combination into a single image. Gamma correction is applied to rebalance the image in step 1207, and the result is a harmonized single virtual nuclear counterstain virtual image in step 1208. The result of step 1208 is combined with the output from step 1203 in step 1209 where registration is performed to align pixels between conventional and virtual nuclear counterstains. A single image is created from the pair from step 1209 in step 1210, where a linear combination function is applied. The image is again balanced in using gamma correction in step 1211 and a harmonized single nuclear counterstain image is produced in step 1212.

In parallel with step 1212, the output of step 1205 is a stack of unmixed virtual and convention biomarker stains seen in step 1213, which may be combined as a stack of images, including a single nuclear counterstain image in step 1214. This fully unmixed set of conventional and virtual biomarker stains, and a counterstain is suitable for further image analysis using conventional methods or to linearly remix for visualization of the combined staining patterns.

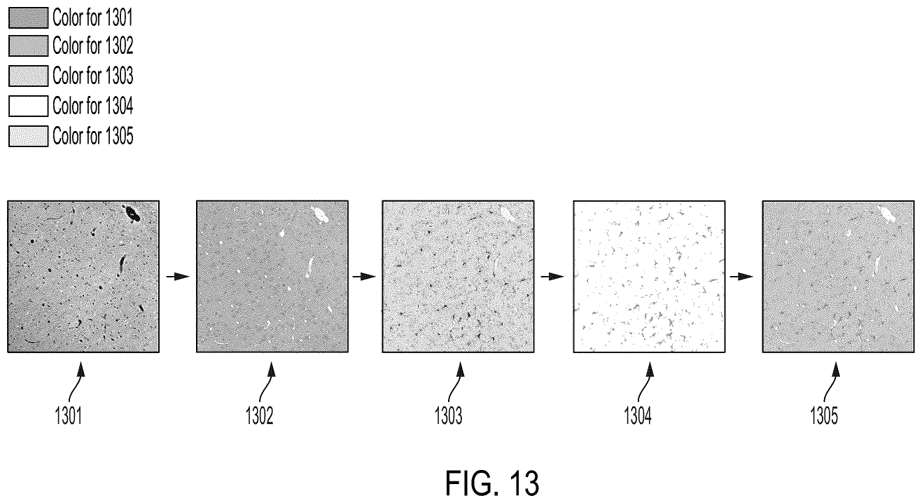

FIG. 13 illustrates an embodiment of a computational workflow for utilizing virtual staining for generating annotations for use in a machine learning model or network as referenced herein. In step 1301, an image of a label-free tissue section is presented to the machine learning model. In step 1302, a virtual staining algorithm is applied to transform the image of the label-free tissue section to a stained tissue. In step 1303, the stained tissue is annotated for extracting additional information, including but not limited to multiplexed immunofluorescence, FISH, proteomics, or sequencing data. The annotations can be done at multiple levels depending on the information extraction modality of the annotation, including but not limited to a pixel level, tile level, or whole slide level. If applicable, the tissue can also be augmented with virtual staining of specific biomarkers. In step 1304, the annotations are parsed using a thresholding operator or another classifier. In step 1305, the virtually stained tissue from step 1302 is overlayed with the annotations parsed in step 1304. The process utilizes spatial matching between the annotations and the data from steps 1302 and 1303 to extract additional information, including but not limited to segmentation or classification.

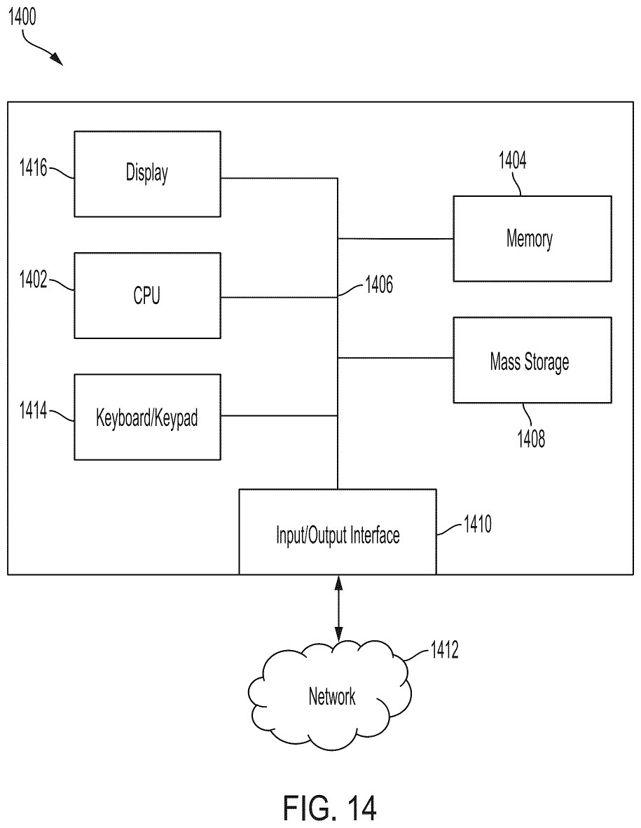

FIG. 14 is block diagram of a computer system 1400 arranged to perform processing associated with the neural network for inference-based virtual staining as described herein. The exemplary computer system 1400 includes a central processing unit (CPU) 1402, a memory 1404, and an interconnect bus 1406. The CPU 1402 may include a single microprocessor or a plurality of microprocessors or special purpose processors for configuring computer system 1400 as a multi-processor system. The memory 1404 illustratively includes a main memory and a read only memory. The computer 1400 also includes the mass storage device 1408 having, for example, various disk drives, tape drives, etc. The memory 1404 also includes dynamic random access memory (DRAM) and high-speed cache memory. In operation, memory 1404 stores at least portions of instructions and data for execution by the CPU 1402. The memory 1404 may also contain compute elements, such as Deep In-Memory Architectures (DIMA), wherein data is sent to memory and a function of the data (e.g., matrix vector multiplication) is read out by the CPU 1402.

The mass storage 1408 may include one or more magnetic disk, optical disk drives, and/or solid state memories, for storing data and instructions for use by the CPU 1402. At least one component of the mass storage system 1408, preferably in the form of a non-volatile disk drive, solid state, or tape drive, stores the database used for processing data and controlling functions of the neural network for inference-based virtual staining. The mass storage system 1408 may also include one or more drives for various portable media, such as a floppy disk, flash drive, a compact disc read only memory (CD-ROM, DVD, CD-RW, and variants), memory stick, or an integrated circuit non-volatile memory adapter (i.e. PC-MCIA adapter) to input and output data and code to and from the computer system 200.

The computer system 1400 may also include one or more input/output interfaces for communications, shown by way of example, as interface 1410 and/or a transceiver for data communications via the network 1412. The data interface 1410 may be a modem, an Ethernet card, or any other suitable data communications device. To provide the functions of a processor running the neural network for inference-based virtual staining, the data interface 1410 may provide a relatively high-speed link to a network 1412, such as an intranet, internet, or the Internet, either directly or through another external interface. The communication link to the network 1412 may be, for example, optical, wired, or wireless (e.g., via satellite or cellular network). The computer system 1400 may also connect via the data interface 1410 and network 1412 to at least one other computer system to perform remote or distributed multi-sensor processing related to, for example, a common operational picture (COP). Alternatively, the computer system 1400 may include a mainframe or other type of host computer system capable of Web-based communications via the network 1412. The computer system 1400 may include software for operating a network application such as a web server and/or web client.

The computer system 1400 may also include suitable input/output ports, that may interface with a portable data storage device, or use the interconnect bus 1406 for interconnection with a local display 1416 and keyboard 1414 or the like serving as a local user interface for programming and/or data retrieval purposes. The display 1416 may include a touch screen capability to enable users to interface with the system 1400 by touching portions of the surface of the display 1416. Server operations personnel may interact with the system 1400 for controlling and/or programming the system from remote terminal devices via the network 1412.

The computer system 1400 may run a variety of application programs and store associated data in a database of mass storage system 1408. One or more such applications may include a neural network for inference-based virtual staining such as described with respect to FIGS. 1-13.

The components contained in the computer system 1400 may enable the computer system to be used as a server, workstation, personal computer, network terminal, mobile computing device, mobile telephone, System on a Chip (SoC), and the like. The system 1400 may include software and/or hardware that implements a web server application. The web server application may include software such as HTML, XML, WML, SGML, PHP (Hypertext Preprocessor), CGI, and like languages.

The foregoing features of the disclosure may be realized as a software component operating in the system 1400 where the system 1400 includes Unix workstation, a Windows workstation, a LINUX workstation, or other type of workstation. Other operation systems may be employed such as, without limitation, Windows, MAC OS, and LINUX. In some aspects, the software can optionally be implemented as a C language computer program, or a computer program written in any high level language including, without limitation, Javascript, Java, CSS, Python, Keras, TensorFlow, PHP, Ruby, C++, C, Shell, C#, Objective-C, Go, R, TeX, VimL, Perl, Scala, CoffeeScript, Emacs Lisp, Swift, Fortran, or Visual BASIC. Certain script-based programs may be employed such as XML, WML, PHP, and so on. The system 200 may use a digital signal processor (DSP).

As stated previously, the mass storage 1408 may include a database. The database may be any suitable database system, including the commercially available Microsoft Access database, and can be a local or distributed database system. A database system may implement Sybase and/or a SQL Server. The database may be supported by any suitable persistent data memory, such as a hard disk drive, RAID system, tape drive system, floppy diskette, or any other suitable system. The system 1400 may include a database that is integrated with the neural network for inference-based virtual staining, however, it will be understood that, in other implementations, the database and mass storage 1408 can be an external element.

In certain implementations, the system 1400 may include an Internet browser program and/or be configured operate as a web server. In some configurations, the client and/or web server may be configured to recognize and interpret various network protocols that may be used by a client or server program. Commonly used protocols include Hypertext Transfer Protocol (HTTP), File Transfer Protocol (FTP), Telnet, and Secure Sockets Layer (SSL), and Transport Layer Security (TLS), for example. However, new protocols and revisions of existing protocols may be frequently introduced. Thus, in order to support a new or revised protocol, a new revision of the server and/or client application may be continuously developed and released.

In one implementation, the neural network includes a network-based, e.g., Internet-based, application that may be configured and run on the system 1400 and/or any combination of the other components of the neural network for inference-based virtual staining. The computer system 1400 may include a web server running a Web 2.0 application or the like. Web applications running on the neural network may use server-side dynamic content generation mechanisms such, without limitation, Java servlets, CGI, PHP, or ASP. In certain implementations, mashed content may be generated by a web browser running, for example, client-side scripting including, without limitation, JavaScript and/or applets on a wireless device.

In certain implementations, the neural network for inference-based virtual staining or computer system 1400 may include applications that employ asynchronous JavaScript+XML (Ajax) and like technologies that use asynchronous loading and content presentation techniques. These techniques may include, without limitation, XHTML and CSS for style presentation, document object model (DOM) API exposed by a web browser, asynchronous data exchange of XML data, and web browser side scripting, e.g., JavaScript. Certain web-based applications and services may utilize web protocols including, without limitation, the services-orientated access protocol (SOAP) and representational state transfer (REST). REST may utilize HTTP with XML.

The neural network for inference-based virtual staining, computer system 1400, or another component of neural network may also provide enhanced security and data encryption. Enhanced security may include access control, biometric authentication, cryptographic authentication, message integrity checking, encryption, digital rights management services, and/or other like security services. The security may include protocols such as IPSEC and IKE. The encryption may include, without limitation, DES, 3DES, AES, RSA, ECC, and any like public key or private key based schemes.

It will be appreciated by those of ordinary skill in the pertinent art that the functions of several elements may, in alternative embodiments, be carried out by fewer elements, or a single element. Similarly, in some embodiments, any functional element may perform fewer, or different, operations than those described with respect to the illustrated embodiment. Also, functional elements shown as distinct for purposes of illustration may be incorporated within other functional elements in a particular implementation (e.g., modules, databases, interfaces, computers, servers and the like may perform any combination of functional elements).

While the subject technology has been described with respect to preferred embodiments, those skilled in the art will readily appreciate that various changes and/or modifications can be made to the subject technology without departing from the spirit or scope of the subject disclosure. The appended claims are exemplary and may be combined and arranged in any manner including with multiple dependencies and the like.

What is claimed is:

1. A method for generating inference-based virtually stained image annotations, comprising:
providing one or more neural networks executed by image processing software running on one or more processors of a computing device;
training the one or more neural networks with a plurality of images of chemical stains of one or more endogenous signals to identify one or more virtual staining patterns;
obtaining data corresponding to a biological sample;
obtaining and producing an image of the biological sample including one or more endogenous signals identified by annotating techniques;
detecting the one or more virtual staining patterns in the image of the biological sample using the one or more neural networks; and
overlaying the virtual staining patterns detected in the image of the biological sample using spatial matching techniques to create inference-based virtually stained image annotations.

2. The method of claim 1, wherein the annotations comprise features used by the one or more neural networks to perform semantic segmentation.

3. The method of claim 1, wherein the obtaining and producing of the image of the biological sample incorporates sequencing or imaging mass spectroscopy.

4. The method of claim 1, wherein the obtaining and producing of the image of the biological sample incorporates an immunohistochemistry or immunofluorescence technique.

5. The method of claim 4, wherein the immunohistochemistry or immunofluorescence technique includes directly comparing virtual staining patterns for two or more antibody clones on the same tissue sections.

6. The method of claim 4, wherein the immunohistochemistry or immunofluorescence technique includes:
creating a unique virtual multiclonal antibody stain from multiple monoclonal clones, and
titering to a desired expression level.

7. The method of claim 1, wherein an opacity level of the virtual staining patterns may be adjusted to enable focusing on specific antibody clones.

8. The method of claim 1, wherein the virtual staining patterns render pattern differences that allow for quantitative analysis.

9. The method of claim 1, further comprising individually manipulating a virtual staining pattern of the overlayed virtual staining patterns.

10. The method of claim 9, wherein manipulation includes adjusting the intensity of each virtual staining pattern in a real time process.

11. The method of claim 1, further comprising multiplexing the overlayed virtual staining patterns with existing virtual stains or conventional assay readouts.

12. A method of generating virtually-stained image annotations, comprising:
obtaining an image of a biological sample;
virtually staining the biological sample using a machine learning algorithm executed via a computer program running on a processor, the machine learning algorithm detecting virtual staining patterns of endogenous signals in the biological sample;
annotating the virtually stained biological sample for a biomarker;
parsing the annotations of the virtually stained biological sample; and
overlaying the virtually stained biological sample with the parsed annotations.

13. The method of claim 12, further comprising semantically segmenting the virtually stained biological sample.

14. The method of claim 12, further comprising training the machine learning algorithm with a plurality of virtual staining patterns of endogenous signals.

15. A method of generating an inference-based virtually stained image, comprising:
providing a neural network executed by image processing software running on one or more processors of a computing device;
training the neural network with a plurality of images of chemical stains of one or more endogenous signals to identify one or more virtual staining patterns;
obtaining and producing an image of a biological sample;
detecting, using the neural network, the virtual staining patterns in the image of the biological sample using the trained neural network;
parsing, using the neural network, the endogenous signals of the detected virtual staining patterns; and
outputting two separate virtual images of each corresponding endogenous signal,
wherein the two separate virtual images depicting the parsed endogenous signals may be combined and re-combined to selectively produce one or more new multiplexed virtual image.
